(19) United States
(12) Patent Application Publication
(10) Pub. No.: US 2008/0211798 A1
(43) Pub. Date: Sep. 4, 2008

(54) Pixel control device and display apparatus utilizing said pixel control device

(75) Inventors: Cheng-Han Tsao, Hsinchu (TW); Yi-Pai Huang, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU Optronics Corp.

(21) Appl. No.: 11/891,236

(22) Filed: Aug. 9, 2007

(30) Foreign Application Priority Data
Mar. 1, 2007 (TW) 096107011

(51) Int. Cl. G09G 5/00; G09G 3/36

(52) U.S. Cl. 345/205; 345/90

(57) ABSTRACT

A pixel control device and a display apparatus using said pixel control device are provided. The pixel control apparatus is electrically connected to a sub-pixel area to provide a first voltage level and a second voltage level to the sub-pixel area. A scan line of the pixel control device transmits a periodic signal to alternately switch on the P type transistor and the N type transistor. A data line transmits the first voltage level to the P type transistor when the P type transistor is switched on and transmits the second voltage level to the N type transistor when the N type transistor is switched on. By providing two different voltage levels, the liquid crystals have different angles in eight domains.

This application claims priority to Taiwan Patent Application No. 096107011 filed on Mar. 1, 2007, the disclosures of which are incorporated herein by reference in its entirety.

### BACKGROUND OF THE INVENTION

1. Field of the Invention

The present invention relates to a pixel control device and a display apparatus utilizing said pixel control device; specifically, it relates to a pixel control device that eliminate the problems of color washout at wide viewing angles and grey level inversion by providing different voltage levels and a display apparatus utilizing said pixel control device.

2. Descriptions of the Related Art

Due to technological and material limitations, earlier liquid crystal displays (LCDs) have provided only a small range of viewing angles, low contrast qualities, and few pixels. In addition, since the earlier LCDs were small, only small devices were equipped with these LCDS. Notebooks, mobile phones, and personal digital assistants (PDAs) are some examples. For those small devices, the range of viewing angles is not a key factor in determining quality. In recent years, many companies have begun to manufacture LCDs with larger dimensions to adapt to desktop computers and televisions. With larger devices, viewing angles become a key factor.

The Fujitsu provides a multi-domain vertical alignment (MVA) technique to solve the aforementioned problem. In the MVA technique, liquid crystals within an LCD do not align in a single direction, so the range of viewing angles can be increased. In addition, LCDs using the MVA technique have a high contrast quality, wide viewing angles, no grey level inversion, high resolution, and rapid response times.

FIG. 1A illustrates a side view of a sub-pixel 1 of an LCD made by a prior MVA technique. The sub-pixel 1 has a first electrode 11, a second electrode 12, a third electrode 13, and a plurality of liquid crystal molecules 14. The liquid crystal molecules 14 are in the same angle when a first voltage level is provided to the first electrode 11 and a second voltage level is provided to both the second electrode 12 and third electrode 13. Under the circumstance, this MVA technique supports four domains. FIG. 1B illustrates a top view of the sub-pixel in the FIG. 1A, wherein the areas indicated by the four dashed circles are the four domains.

However, the MVA technique of the prior art leads to color washout and grey level inversion at wide viewing angles. A color washout occurs when the chrominance of the displayed images is greatly reduced at wide viewing angles. Grey level inversions occur when the brightness of the displayed images is reversed at wide viewing angles. Both of these problems are not desirable features for an LCD.

Current techniques can only solve color washout and grey level inversion for LCDs made by the a-si process. Only few are addressed using the low temperature poly silicon (LTPS) process. Because LCDs made by the LTPS process have rapid responses, high intensities, and high resolutions, the LCD quality can be greatly improved if both color washout and grey level inversion can be eliminated. On the other hand, LCDs made using the transflective technique have become increasingly popular because of their great readability under the sun and low power consumption. In the transflective technique, transmissions and reflections require different grey level curves, which are achieved by using different cell gaps for transmissions and reflections in the prior art. However, the manufacturing processes of the transflective technique are extremely difficult and expensive. Furthermore, multiple cell gap techniques result in the abnormal alignment of liquid crystals at the interface and thus, decrease the display quality.

According to the aforementioned descriptions, it is important to eliminate color washout and grey level inversions at wide viewing angles in LCDs made by the LTPS process and to provide multiple grey level curves for transflection techniques using only a single cell gap.

### SUMMARY OF THE INVENTION

An objective of the present invention is to provide a pixel control device. The pixel control apparatus is connected to a sub-pixel. The pixel control device is configured to provide a first voltage level and a second voltage level to the sub-pixel. The pixel control device comprises a P type transistor, an N type transistor, a scan line, and a data line. The scan line is configured to transmit a periodic signal to control the P type transistor and the N type transistor to be alternately switched on. The data line is configured to transmit a first data referenced voltage level to the P type transistor when the P type transistor is switched on. The data line is configured to transmit a second data referenced voltage level to the N type transistor when the N type transistor is switched on. The first voltage level and the first data referenced voltage level form a first ratio, while the second voltage level and the second data referenced voltage level form a second ratio.

Another objective of the present invention is to provide a display apparatus. The display apparatus comprises a display array and a pixel control device. The display array has a plurality of pixels. Each of the pixels has a plurality of sub-pixels. The pixel control device is electrically connected to one of the sub-pixels. The pixel control device is configured to provide a first voltage level and a second voltage level to the connected sub-pixel. The pixel control device comprises a P type transistor, an N type transistor, a scan line, and a data line. The scan line is configured to transmit a periodic signal to control the P type transistor and the N type transistor to be alternately switched on. The data line is configured to transmit a first data referenced voltage level to the P type transistor when the P type transistor is switched on. The data line is configured to transmit a second data referenced voltage level to the N type transistor when the N type transistor is switched on. The first voltage level and the first data referenced voltage level form a first ratio, while the second voltage level and the second data referenced voltage level form a second ratio.

Based on the aforementioned arrangements, the pixel control device of the present invention alternately switches on a P type transistor and an N type transistor to provide two voltage levels and to further control the tilting angles of the liquid crystal molecules in a display apparatus. By using two voltage levels, a sub-pixel of the display apparatus is divided into two areas. Since each of the area has four domains, the sub-pixel has eight domains. Consequently, color washouts in an LCD made by the LTPS process are eliminated. The arrangement of the present invention can be adapted to a transflective display apparatus as well by providing different curves of grey levels to achieve transflection.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A illustrates a side view of a sub-pixel of an LCD made by the prior MVA technique;

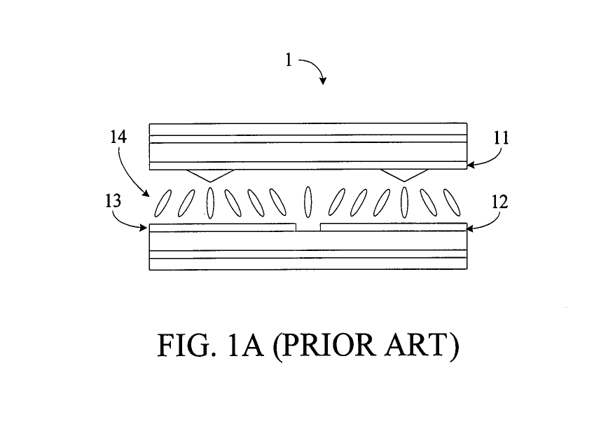

FIG. 1B illustrates a top view of FIG. 1A;

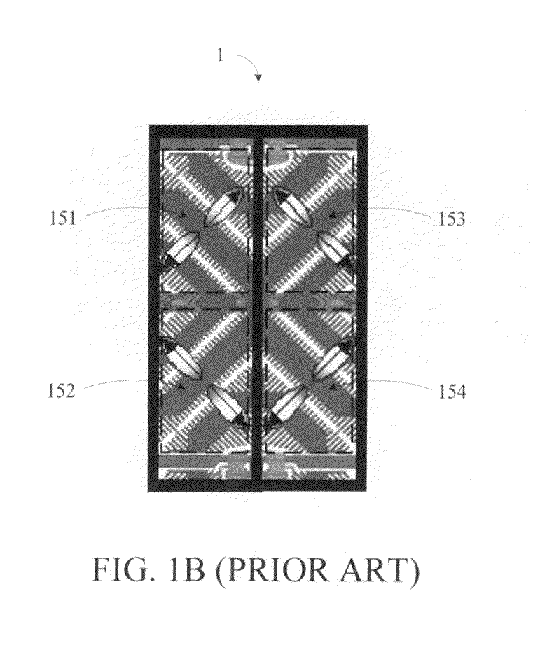

FIG. 2 illustrates a sub-pixel of an LCD of the present invention;

FIG. 3A illustrates a display apparatus of an embodiment of the present invention;

FIG. 3B illustrates a pixel control device of the embodiment of the present invention; and

FIG. 3C illustrates signals of the scan line and the data line of the embodiment of the present invention.

### DESCRIPTION OF THE PREFERRED EMBODIMENT

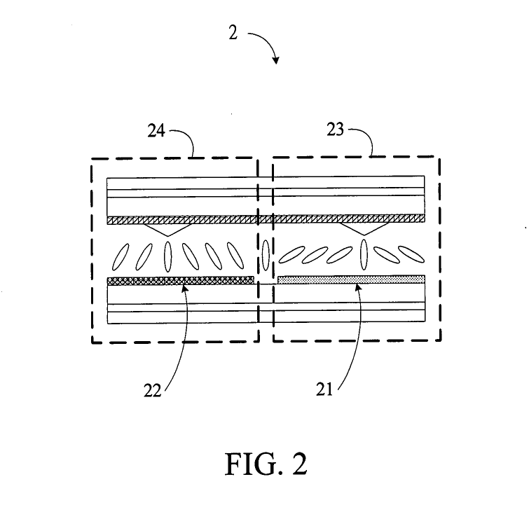

FIG. 2 illustrates a sub-pixel 2 of a liquid crystal display (LCD) of the present invention. The sub-pixel 2 of the present invention is divided into two areas, i.e. a first area 23 and a second area 24, by providing two different voltage levels to a first electrode 21 and a second electrode 22 of the sub-pixel 2. Liquid crystal molecules in the first area 23 and second area 24 are respectively tilted in different angles according to the two different voltage levels. Since each voltage level creates four domains in each area, each of the sub-pixels of the present invention has eight domains.

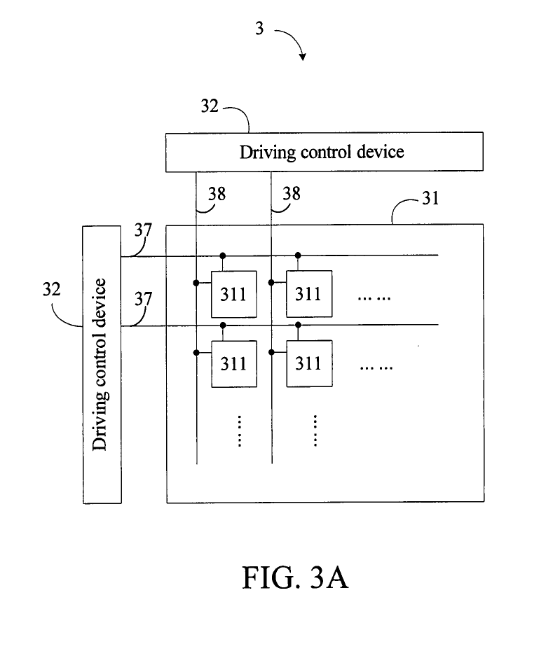

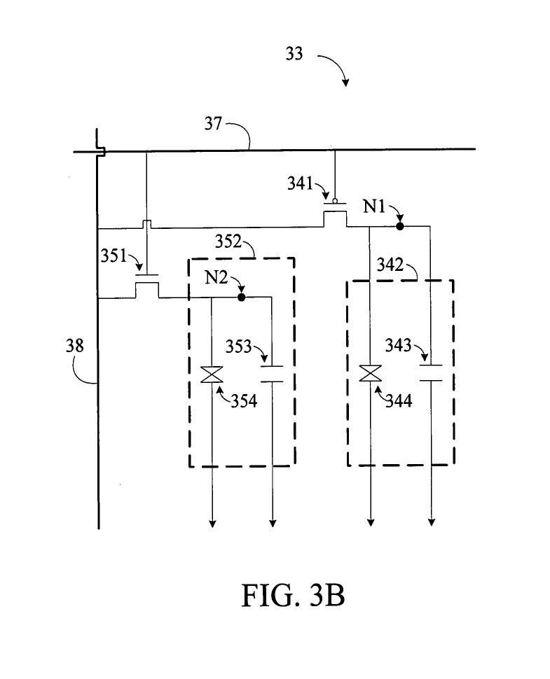

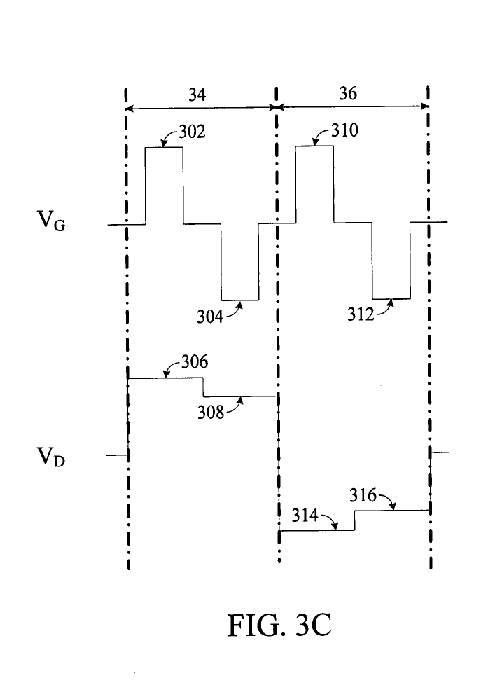

FIG. 3A, FIG. 3B, and FIG. 3C illustrates an embodiment of the present invention. FIG. 3A illustrates a display apparatus 3 of the embodiment, wherein the display apparatus 3 comprises a display array 31 and driving control devices 32. While the display array 31 has a plurality of pixels 311, each of the pixels has a plurality of sub-pixels to determine the luminance and chrominance of the pixel. FIG. 3B illustrates a pixel control device 33 of the present invention. The pixel control device 33 is electrically connected to one of the sub-pixels of the display apparatus 3 for providing a first voltage level and a second voltage level to two electrodes of the sub-pixel, i.e. the first electrode 21 and the second electrode 22 in FIG. 2. The liquid crystal molecules are tilted in different angles according to the first voltage level and second voltage level, thus achieving eight domains in each sub-pixel.

More specifically, the pixel control device 33 comprises a P type transistor 341, an N type transistor 351, a first energy storing device 342, a second energy storing device 352, a scan line 37, and a data line 38. Both the P type transistor 341 and the N type transistor 351 have a gate, a source, and a drain, respectively. The gate of the P type transistor 341 is coupled to the scan line 37, while the source of the P type transistor 341 is coupled to the data line 38. The drain of the P type transistor 341 is coupled to the first energy storing device 342. Similarly, the gate of the N type transistor 351 is coupled to the scan line 37, while the source of the N type transistor 351 is coupled to the data line 38. The drain of the N type transistor 351 is coupled to the second storing device 352. The first energy storing device 342 generates a first voltage level at a node N1, which is transmitted to the first electrode, such as the first electrode 21 in FIG. 2, of the sub-pixel. The second energy storing device 352 generates a second voltage level at a node N2, which is transmitted to the second electrode, such as the second electrode 22 in FIG. 2, of the sub-pixel.

The scan line 37 transmits a periodic signal to control the P type transistor 341 and the N type transistor 351 to be alternately switched on. The data line 38 transmits a first data referenced voltage level to the P type transistor 341 when the P type transistor 341 is switched on and transmits a second data referenced voltage level to the N type transistor 351 when the N type transistor 351 is switched on. The signals transmitted by the scan line 37 and the data line 38 are illustrated in FIG. 3C, wherein signal V_{G} represents the signal transmitted by the scan line 37 and signal V_{D} represents the signal transmitted by the data line 38. When a first frame is processing, the scan line 37 transmits the signal V_{G} of a first period 34. During the first period 34, the N type transistor 351 is switched on when the signal V_{G} is at a high voltage level (as indicated by arrow 302). At this time period, the signal V_{D} provides the second data referenced voltage level (as indicated by arrow 306) to the N type transistor 351. The second voltage level and the second data referenced voltage level have a second ratio, wherein the second ratio is determined according to the second energy storing device 352, which is described later. Similarly, the N type transistor 351 is switched off and the P type transistor 341 is switched on when the signal V_{G} is at a low voltage level (as indicated by arrow 304). At this time period, the signal V_{D} provides the first data referenced voltage level (as indicated by arrow 308) to the P type transistor 341. The first voltage level and the first data referenced voltage level have a first ratio, wherein the first ratio is determined according to the first energy storing device 342, which is described later. When the next frame is processing, the scan line 37 transmits the signal V_{G} of a second period 36. Due to the characteristics of liquid crystal molecules, the voltage level transmitted by the data line 38 and the first period 34 have to be inverted in phase. During the second period 36, the P type transistor 341 is switched off and the N type transistor 351 is switched on when the signal V_{G} is at a high voltage level (as indicated by arrow 310). At this time period, the signal V_{D} provides an inverted voltage level of the second data referenced voltage level (as indicated by arrow 314) to the N type transistor 351. Similarly, the N type transistor 351 is switched off and the P type transistor 341 is switched on when the signal V_{G} is at a low voltage level (as indicated by arrow 312). At this time period, the signal V_{D} provides an inverted voltage level of the first data referenced voltage level (as indicated by arrow 316) to the P type transistor 341.

More specifically, the first energy storing device 342 comprises a first capacitor 343 and a second capacitor 344, as shown in FIG. 3B, to generate the first voltage level in response to the first data referenced voltage level. Each of the capacitors has a first terminal and a second terminal. The first capacitor 343 has a fixed capacitance with its first terminal coupled to the drain of the P type transistor 341, and its second terminal grounded. The second capacitor 344 has a variable capacitance and is connected to the first capacitor 343 in parallel. The aforementioned first ratio can be adjusted according to the variable capacitance of the second capacitor 344. That is, the first ratio is determined according to the electric charging ability of the first energy storing device 342. To be more specific, when the P type transistor 341 is switched on, the first data referenced voltage level charges the first energy storing device 342. The charging time of the first energy storing device 342 is determined by the value of the variable capacitance of the second capacitor 344. After a period of time, the voltage level (i.e. the first voltage level) of the node N1 is outputted to the first electrode 21.

The second energy storing device 352 comprises a third capacitor 353 and a fourth capacitor 354 to generate the second voltage level in response to the second data referenced voltage level. Each of the capacitors has a first terminal and a second terminal. The third capacitor 353 has a fixed capacitance, with its first terminal coupled to the drain of the N type transistor 351, and its second terminal grounded. The fourth capacitor 354 has a variable capacitance and is connected to the third capacitor 353 in parallel. The aforementioned second ratio can be adjusted according to the variable capacitance of the fourth capacitor 354. That is, the second ratio is determined according to the electric charging ability of the second energy storing device 352. More specifically, when the N type transistor 351 is switched on, the second data referenced voltage level charges the second energy storing device 352. The charging time of the second energy storing device 352 is determined by the value of the variable capacitance of the fourth capacitor 354. After a period of time, the voltage level (i.e. the second voltage level) of the node N2 is outputted to the first electrode 22. According to the aforementioned arrangement, a sub-pixel is divided into two areas, wherein the P type transistor controls and transmits the voltage level to one of the areas and the N type transistor controls and transmits the voltage level to the other area. Since the voltage level transmitted by the P type transistor is different from the voltage level transmitted by the N type transistor, the liquid crystal molecules in the two areas have different tilting angles and form eight domains. Thus, the color washouts at wide viewing angles are eliminated.

On the other hand, since the aforementioned arrangement provides two voltage levels to a sub-pixel, different grey level curves can be generated. Consequently, using a single gap process can provide multiple grey level curves required by a transflective apparatus, and thereby, avoid the abnormal alignment of the liquid crystals.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A pixel control device for controlling a sub-pixel, comprising:
a P type transistor;
an N type transistor;
a scan line for transmitting a periodic signal to control the P type transistor and the N type transistor to be alternately switched on; and
a data line for transmitting a first data referenced voltage level to the P type transistor when the P type transistor is switched on, and transmitting a second data referenced voltage level to the N type transistor when the N type transistor is switched on,
wherein the pixel control device is configured to provide a first voltage level and a second voltage level to the sub-pixel, the first voltage level and the first data referenced voltage level have a first ratio and the second voltage level and the second data referenced voltage level have a second ratio.

2. The pixel control device of claim 1, wherein each of the P type transistor and the N type transistor has a gate, a source, and a drain, the gate of the P type transistor and the gate of the N type transistor are both coupled to the scan line, and the source of the P type transistor and the source of the N type transistor are both coupled to the data line.

3. The pixel control device of claim 2, further comprising:
a first energy storing device coupled to the drain of the P type transistor, for providing the first voltage level in response to the first data referenced voltage level when the P type transistor is switched on; and
a second energy storing device coupled to the drain of the N type transistor, for providing the second voltage level in response to the second data referenced voltage level when the N type transistor is switched on.

4. The pixel control device of claim 3, wherein the first energy storing device comprises:
a first capacitor with fixed capacitance coupled to the drain of the P type transistor; and
a second capacitor with variable capacitance coupled to the drain of the P type transistor.

5. The pixel control device of claim 3, wherein the second energy storing device comprises:
a third capacitor with fixed capacitance coupled to the drain of the N type transistor; and
a fourth capacitor with variable capacitance coupled to the drain of the N type transistor.

6. The pixel control device of claim 3, wherein the first ratio is determined by the first energy storing device and the second ratio is determined by the second energy storing device.

7. A display apparatus, comprising:
a display array having a plurality of pixels, each of the pixels having a plurality of sub-pixels; and
a pixel control device electrically connected to one of the sub-pixels, the pixel control device being configured to provide a first voltage level and a second voltage level to the connected sub-pixel, the pixel control device comprising:
a P type transistor;
an N type transistor;
a scan line for transmitting a periodic signal to control the P type transistor and the N type transistor to be alternately switched on; and
a data line for transmitting a first data referenced voltage level to the P type transistor when the P type transistor is switched on, and transmitting a second data referenced voltage level to the N type transistor when the N type transistor is switched on,
wherein the first voltage level and the first data referenced voltage level have a first ratio and the second voltage level and the second data referenced voltage level have a second ratio.

8. The display apparatus 7, wherein each of the P type transistor and the N type transistor has a gate, a source, and a drain, the gate of the P type transistor and the gate of the N type transistor are both coupled to the scan line, and the source of the P type transistor and the source of the N type transistor are both coupled to the data line.

9. The display apparatus of claim 8, further comprising:
a first energy storing device coupled to the drain of the P type transistor, for providing the first voltage level in response to the first data referenced voltage level when the P type transistor is switched on; and
a second energy storing device coupled to the drain of the N type transistor, for providing the second voltage level in response to the second data referenced voltage level when the N type transistor is switched on.

10. The display apparatus of claim 9, wherein the first energy storing device comprises:
a first capacitor with fixed capacitance coupled to the drain of the P type transistor; and
a second capacitor with variable capacitance coupled to the drain of the P type transistor.

11. The display apparatus of claim 9, wherein the second energy storing device comprises:
a third capacitor with fixed capacitance coupled to the drain of the N type transistor; and
a fourth capacitor with variable capacitance coupled to the drain of the N type transistor.

12. The display apparatus of claim 9, wherein the first ratio is determined by the first energy storing device and the second ratio is determined by the second energy storing device.

13. The display apparatus of claim 7, wherein the display apparatus is a liquid crystal display.
